(19) United States
(12) Patent Application Publication
(10) Pub. No.: US 2006/0227682 A1
(43) Pub. Date: Oct. 12, 2006

(54) Determination of optimum writing strategy for recording data onto recordable optical disk

(75) Inventors: Shun-Yi Tung, Kweishan (TW); Wu-Song Lee, Kweishan (TW)

Correspondence Address: Richard P. Berg, Esq.;c/o LADAS & PARRY, Suite 2100, 5670 Wilshire Boulevard, Los Angeles, CA, 90036-5679, US

(73) Assignee: BENQ CORPORATION

(21) Appl. No.: 11/399,946

(22) Filed: Apr. 7, 2006

(30) Foreign Application Priority Data
Apr. 8, 2005 (TW) 094111126

(51) Int. Cl. G11B 7/12

(52) U.S. Cl. 369/47.5

(57) ABSTRACT

The invention is to provide a method for determining an optimum writing strategy for an optical disk drive to record data onto a recordable optical disk. According to a preferred embodiment of the method of the invention, a pre-stored third type datum is retrieved from the recordable optical disk. Then, a step of judgment is performed to judge if the third type datum matches one of the plurality of first type data stored in the optical disk drive, and each of the plurality of first type data maps one of the first writing strategies. If the result is NO, a second writing strategy, of which the mapped second type datum matches the third type datum, is loaded from a remote server, and the loaded second writing strategy is determined as the optimum writing strategy.

### FIELD OF THE INVENTION

The present invention relates to a method for determining an optimum writing strategy for an optical disk drive to record data onto a recordable optical disk, and more particularly, the optimum writing strategy can be downloaded from a remote server.

### DESCRIPTION OF THE PRIOR ART

Most of the designs for optical disk drives, which can record data onto recordable optical disks, have distinct writing strategies for different recordable optical disks, so as to achieve better recording quality. These distinct writing strategies are established as a look-up table which is stored in a firmware of the optical disk drive in accordance with the type of the recordable optical disks. Furthermore, these writing strategies are updated with the updating of the firmware.

However, using this way of updating writing strategies, by updating of the firmware, often results in the situation that the optimum writing strategy cannot be adopted to record data onto a recordable optical disk; since the firmware cannot be updated frequently, the updating of the writing strategies is also too slow. Furthermore, because the memory space of the optical disk drive is limited, the writing strategies are selectively stored in the memory, so some of the writing strategies are sacrificed. Therefore, there is no assured way that the optimum writing strategy is selected to record data onto the optical disk.

Accordingly, an objective of the invention is to provide a method for determining an optimum writing strategy to solve the problem mentioned above.

### SUMMARY OF THE INVENTION

An objective of the invention is to provide a method for determining an optimum writing strategy. The optimum writing strategy is used for an optical disk drive to record data onto a recordable optical disk.

According to an embodiment of the invention, first, a pre-stored third type datum is retrieved from the recordable optical disk. Then, a judging step is performed to judge if the third type datum matches one of the plurality of first type data stored in the optical disk drive; each of the plurality of first type data maps one of the first writing strategies. Finally, if the result is NO, a second writing strategy, of which the mapped second type datum matches the third type datum, is loaded from a remote server, and the loaded second writing strategy is determined as the optimum writing strategy.

The method for determining an optimum writing strategy of the invention employs a memory in the optical disk drive, which is capable of being accessed frequently, and the memory communicates with a remote server to update the writing strategies timely, so that the users can adopt the optimum writing strategy to record data onto the optical disk.

The advantage and spirit of the invention may be understood by the following recitations together with the appended drawings.

### BRIEF DESCRIPTION OF THE APPENDED DRAWINGS

FIG. 1 is a flowchart illustrating the procedure of the method for determining an optimum writing strategy according to a preferred embodiment of the invention.

FIG. 2 is a flowchart illustrating the control procedure of a host which applies the invention.

### DETAILED DESCRIPTION OF THE INVENTION

The purpose of the invention is to provide a method for determining an optimum writing strategy. The optimum writing strategy is used for an optical disk drive to record data onto a recordable optical disk.

A plurality of first writing strategies and a plurality of first type data, which each maps one of the first writing strategies, are stored in the optical disk drive. A plurality of second writing strategies and a plurality of second type data, which each maps one of the second writing strategies, are stored in a remote server capable of communicating with the optical disk drive. The recordable optical disk has a pre-stored third type datum.

The method is, first, to retrieve the third type datum from the recordable optical disk. A judging step is then performed to judge if the third type datum matches one of the first type data stored in the optical disk drive. Finally, if the result is NO, a second writing strategy, of which the mapped second type datum matches the third type datum, is loaded from a remote server, and the loaded second writing strategy is determined as the optimum writing strategy.

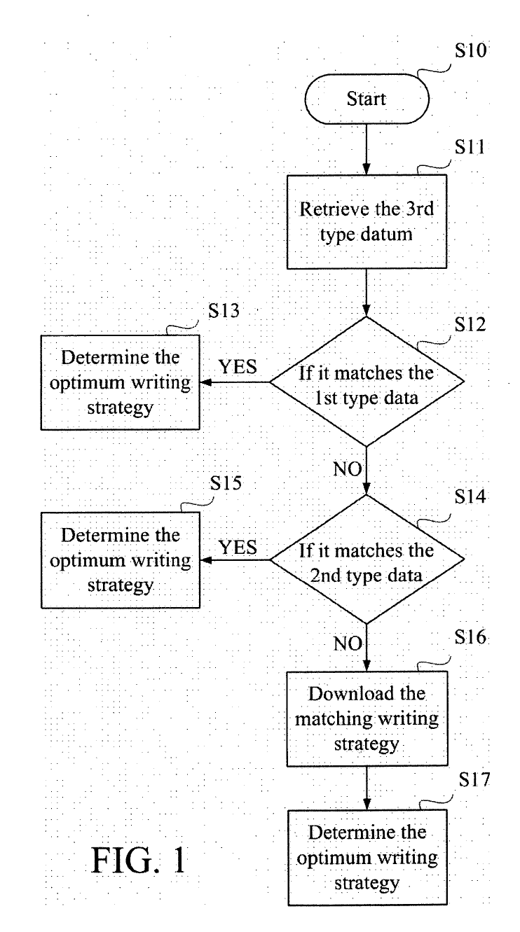

Referring to FIG. 1, FIG. 1 is a flowchart illustrating the procedure of the method for determining an optimum writing strategy according to a preferred embodiment of the invention.

In this embodiment, the optical disk drive includes a first buffer for storing the plurality of first type data and the plurality of first writing strategies, and a second buffer for storing the loaded second writing strategy and the second type datum mapping the loaded second writing strategy if there is any. The recordable optical disk has a pre-stored third type datum.

The objective of the procedure of the method for determining a writing strategy is to determine an optimum writing strategy for an optical disk drive to record data onto a recordable optical disk. The optimum writing strategy can be determined easily and reliably in accordance with the method of the invention.

As shown in FIG. 1, the procedure of the method for determining an optimum writing strategy according to a preferred embodiment of the invention is, first, to perform step S10 to set the initial conditions. Next, step S11 is performed to retrieve the third type datum from the recordable optical disk. Step S12 is then performed to judge if the third type datum matches one of the first type data stored in the first buffer of the optical disk drive. If the result in step S12 is YES, step S13 is performed. In step S13, the first writing strategy, of which the mapped first type datum matches the third type datum, is determined as the optimum writing strategy. If the result in step S12 is NO, step S14 is then performed to judge if the third type datum matches one of the loaded second type data stored in the second buffer of the optical disk drive. If the result in step S14 is YES, step S15 is performed. In step S15, the second writing strategy, of which the mapped second type datum matches the third type datum, is determined as the optimum writing strategy. If the result in step S14 is NO, step S16 is then performed. In step S16, the second writing strategy, of which the mapped second type datum matches the third type datum, is loaded from a remote server. Step S17 is then performed to determine the loaded second writing strategy as the optimum writing strategy.

In an embodiment, the recordable optical disk is a CD-R disk or a CD-RW disk.

In an embodiment, the optimum writing strategy includes the power of a writing pulse, a duty cycle of the writing pulse, the power of an erasing pulse, a duty cycle of the erasing pulse, the power of a reading pulse, and a duty cycle of the reading pulse.

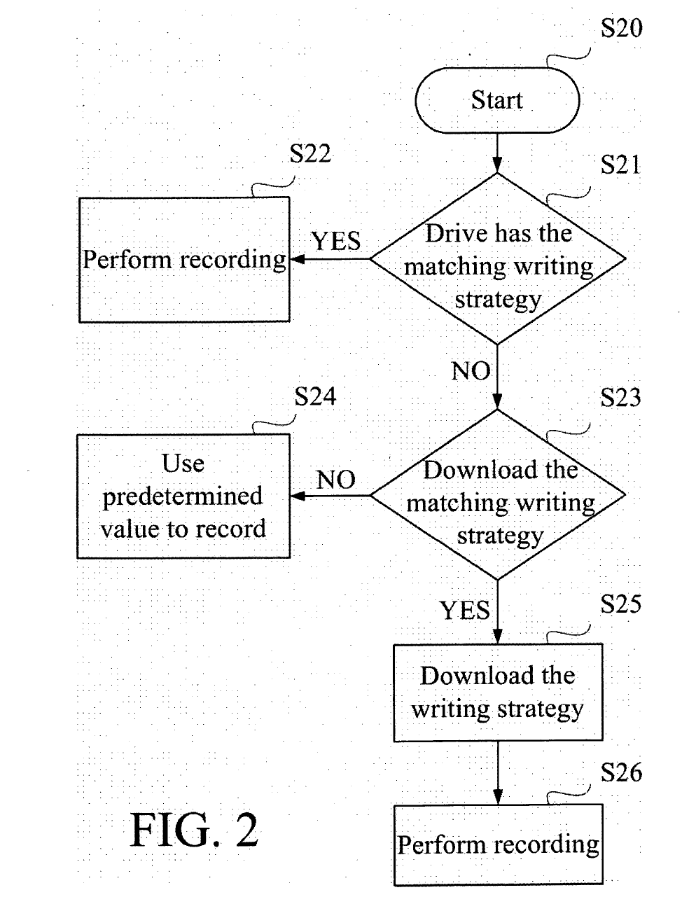

In practical application, the optical disk drive is capable of communicating with a host, and a user can control the optical disk drive by the host via an interface. Referring to FIG. 2, FIG. 2 is a flowchart illustrating the control procedure of a host which applies the invention. First, when an optical disk is placed in the optical disk drive, the host receives a start message and performs step S20 to set the initial conditions. Next, step S21 is performed. In step S21, the host transmits an instruction to the optical disk drive to make the optical disk drive transmit back a datum; by judging the datum, it can find out if the optical disk drive has the writing strategy that can match the optical disk. If the optical disk drive has the matching writing strategy, step S22 is performed. In step S22, the host transmits an instruction to the optical disk drive to make the optical disk drive employ the mapped writing strategy to record data onto the optical disk. If the optical disk drive doesn't have the matching writing strategy, step S23 is performed. In step S23, the user controls the host via the interface to determine whether to download a matching writing strategy from a remote server. If the user determines not to download the matching writing strategy, the host performs step S24. In step S24, the host transmits an instruction to the optical disk drive to make the optical disk drive employ a predetermined writing strategy to record data onto the optical disk. If the user determines to download the matching writing strategy, the host performs step S25. In step S25, the host downloads the matching writing strategy from the remote server and stores the matching writing strategy in a buffer of the optical disk drive. Finally, step S26 is performed to employ the matching writing strategy stored in the optical disk drive to record data onto the optical disk.

In practical application, the optical disk drive can be a CD/DVD recordable drive of the computer peripheries or a video recorder. If it is applied in a video recorder, the video recorder is capable of communicating with a remote server. First, a type datum is accessed from a mounted VCD, and then the video recorder judges if a writing strategy matching the type datum of the VCD is stored in the video recorder. If there is no matching writing strategy, a writing strategy matching the type datum of the VCD is downloaded from the remote server via Internet. Therefore, an optimum writing strategy is acquired easily and reliably.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A method for determining an optimum writing strategy for an optical disk drive to record data onto a recordable optical disk, a plurality of first writing strategies and a plurality of first type data being stored in the optical disk drive, each first type data mapping one of the first writing strategies, a plurality of second writing strategies and a plurality of second type data being stored in a remote server capable of communicating with the optical disk drive, each second type data mapping one of the second writing strategies, the recordable optical disk having a pre-stored third type datum, said method comprising the steps of:
(a) retrieving the third type datum from the recordable optical disk;
(b) judging if the third type datum matches one of the first type data stored in the optical disk drive; and
(c) if NO in step (b), loading from the remote server the second writing strategy, of which the mapped second type datum matches the third type datum, into the optical disk drive, and determining the loaded second writing strategy as the optimum writing strategy for the optical disk drive to record data onto the recordable optical disk.

2. The method of claim 1, further comprising the step of:
(d) if YES in step (b), determining the first writing strategy, of which the mapped first type datum matches the third type datum, as the optimum writing strategy for the optical disk drive to record data onto the recordable optical disk.

3. The method of claim 1, wherein the optical disk drive comprises a first buffer for storing the first type data and the first writing strategies, and a second buffer for storing the loaded second writing strategy and the second type datum mapping the loaded second writing strategy.

4. The method of claim 1, wherein the recordable optical disk is one selected from the group consisting of a CD-R disk and a CD-RW disk.

5. The method of claim 1, wherein the optimum writing strategy comprises the power of a writing pulse, a duty cycle of the writing pulse, the power of an erasing pulse, a duty cycle of the erasing pulse, the power of a reading pulse, and a duty cycle of the reading pulse.
